(19) United States
(12) Patent Application Publication
(10) Pub. No.: US 2022/0000316 A1
(43) Pub. Date: Jan. 6, 2022

(54) Cooking Vessel Provided With An Improved Tubular Handle

(71) Applicant: SEB S.A., Ecully (FR)

(72) Inventor: Laurent Guegan, Lornay (FR)

(73) Assignee: SEB S.A., Ecully (FR)

(21) Appl. No.: 17/291,510

(22) PCT Filed: Nov. 22, 2019
(86) PCT No.: PCT/EP2019/082315

§ 371 Date: May 5, 2021

(30) Foreign Application Priority Data
Nov. 30, 2018 (FR) 1872137

(51) Int. Cl. A47J 45/06

(52) U.S. Cl. CPC A47J 45/061

(57) ABSTRACT

The invention relates to a cooking vessel (1) intended to be placed on a heating source, said cooking vessel (1) comprising a side wall (4) and a handle (10) fixed on said side wall (4) by fastening elements (15, 16), said handle (10) having a tubular gripping part (11) which extends radially to the lateral wall (4) in a longitudinal direction X, said tubular gripping part (11) having an attachment end (12) and a free end (13) provided with an orifice (14). According to the invention, the attachment end (12) is closed by an end wall (19, 19a) distant from the side wall by at least 2 millimetres in order to form a channel (7) between the side wall (4) and the end wall (19, 19a), and the attachment end (123) comprises a closed bottom wall (17) and an upper wall (18) provided with at least one through opening (20, 20a) arranged adjacent to the end wall (19, 19a) so that rising hot currents which during cooking travel along the side wall (4), in the place where the handle (10) is attached, create suction near the at least one opening (20, 20a) in order to generate an air flow from the orifice (14) to the inside of the tubular gripping portion (11) and thereby cool it.

The present invention relates to a cooking vessel intended for cooking food and which comprises a tubular handle, particularly a frying pan, a saucepan, or a sauteuse. Such a cooking vessel is intended to be placed on a source of heat such as a gas stove.

Known from document EP0240225 is a handle intended to be secured to a sidewall of a cooking vessel. The handle comprises an attachment portion prolonged by a tubular gripping part that extends radially to the wall in a longitudinal direction and which has a free end provided with an orifice.

The tubular gripping part comprises an attachment end and the attachment end comprises a bottom wall provided with a first through opening and an upper wall provided with a second through opening. The first and second openings are arranged so as to be adjacent to the side wall. During cooking on a heat source, particularly a gas stove, rising hot currents that travel along the side wall where the handle is attached pass through the first and second openings. A portion of these hot currents can be deviated after passing into the first opening to the interior of the tubular gripping part, going out again through the orifice of the free end.

Thus, the gripping zone can be heated during cooking and can reach an excessive temperature so that a user can grip it without means of protection, such as a glove.

The purpose of the present invention is to remedy the aforementioned disadvantages and to propose a cooking vessel provided with a tubular handle having a construction optimized to allow the user to manipulate it in complete safety, particularly at the level of the temperature of a gripping part of the tubular handle.

Another purpose of the invention is to propose a cooking vessel provided with a tubular handle with a design that is simple and economical to use.

These purposes are achieved with a cooking vessel intended to be placed on a source of heat, said cooking vessel comprising a side wall and a handle attached to said side wall by attachment members, said handle comprising a tubular gripping part that extends radially to the wall along a longitudinal direction, said tubular gripping part having an attachment end and a free end provided with an orifice, characterized in that the attachment end is closed by an end wall distant from the side wall by at least 2 mm in order to form a channel between the side wall and the end wall and in that the attachment end comprises a closed bottom wall and an upper wall provided with at least one through opening arranged to be adjacent to the end wall so that rising hot currents which during cooking travel along the side wall in the place where the handle is attached, create a suction at the at least one opening in order to generate an air current from the orifice toward the interior of the tubular gripping part and thereby cool it.

The temperature of the gripping part of the handle is therefore kept at a sufficiently low temperature by the current of cool air that circulates in the tubular handle so that a user can grasp the gripping part without protective means at any time during cooking.

The end wall distant from the side wall by at least 2 mm makes it possible to separate the attachment end from the very hot side wall during cooking and enables formation of a channel for passage of part of the hottest rising currents that travel along the side wall. Thus, the raising of the temperature of the gripping part is slowed down.

Preferably, the attachment members comprise two side tabs that extend vertically and along the longitudinal direction between the attachment end and the side wall.

Thus, rising hot currents that travel during cooking along the side wall at the location where the handle is attached are not hindered by the two side tabs that extend vertically in the direction of their travel.

Advantageously, the channel defined laterally by the side tabs has an intake section and an outlet section of the rising hot currents, the intake section being greater than the outlet section.

Thus, the speed of travel of the rising hot currents is accelerated into the channel and the negative pressure at the through opening is improved.

Advantageously, the at least one opening extends along the longitudinal direction over at least 5 mm, preferably over at least 10 mm.

Thus, the at least one opening includes two sides that extend along the longitudinal direction, each side creating a zone of release of rising hot currents that travel during cooking along the side wall and around the attachment end of the tubular gripping part in order to generate a negative pressure above the through opening.

Preferably, the at least one through opening has a surface area of more than 100 mm², preferably more than 200 mm².

Such a surface area allows the rising currents to create a suction at the at least one opening in order to generate sufficient airflow inside the tubular gripping part in order to cool it to an acceptable temperature for gripping with a bare hand.

Advantageously, the end wall comprises an upper edge that partially defines the at least one through opening.

Thus, the upper edge creates a zone of release of rising hot currents that travel during cooking along the side wall and around the attachment end of the tubular gripping part in order to generate a negative pressure above the through opening.

Advantageously, the handle comprises a vertical plane of symmetry that extends along the longitudinal direction. Thus, in a case where the upper wall is provided with only one through opening, this through opening extends on either side of the plane of symmetry.

Advantageously, the at least one through opening is trapezoidal in shape, the base whereof is formed by the upper edge, the upper edge being distant from the side wall by at least 10 mm, preferably at least 20 mm.

Advantageously, the trapezoidal shape comprises a large base and a small base, the large base being formed by the upper edge.

Preferably, the trapezoidal shape comprises two sides that extend along the longitudinal direction X, the upper edge as well as each side creating a zone of release of rising hot currents that travel during cooking along the side wall and around the attachment end of the tubular gripping part in order to generate a negative pressure above the through opening.

Preferably, the upper edge is V-shaped with a rounded point.

Thus, the upper edge is longer and the negative pressure above the through opening is greater.

Advantageously, the tubular gripping part is produced from austenitic stainless steel.

The austenitic stainless steel has a low thermal conductivity that enables the thermal flow by conduction to the gripping part to be slowed.

Preferably, the tubular gripping part has a thickness of less than 3 mm, preferably less than 2 mm.

This arrangement makes it possible to obtain a good compromise between the smallest possible thickness for thermal reasons and sufficient thickness for good mechanical strength.

Preferably, the gripping part comprises only one through opening between the end wall and the orifice.

Thus, the negative pressure created at the single opening by the rising hot currents that travel along the side wall can only cause a circulation of cool air in the tubular gripping part from the orifice.

Advantageously, the cooking vessel is a frying pan, a saucepan, or a sauteuse.

The purposes, aspects and advantages of the present invention will be better understood from the following description of particular embodiments of the invention presented by way of non-limiting examples, with reference to the appended drawings in which:

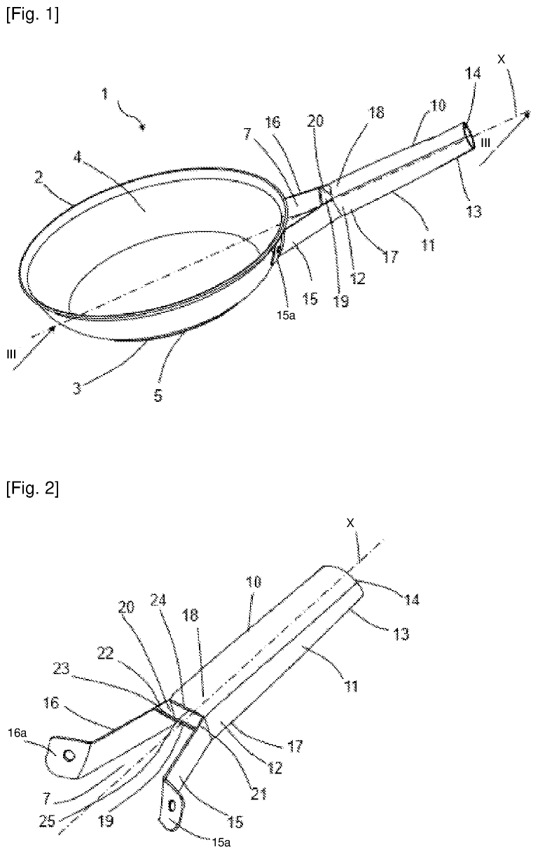

FIG. 1 is a perspective view of a cooking vessel provided with a tubular handle according to a first particular embodiment of the invention,

FIG. 2 is a perspective view of the tubular handle depicted in FIG. 1,

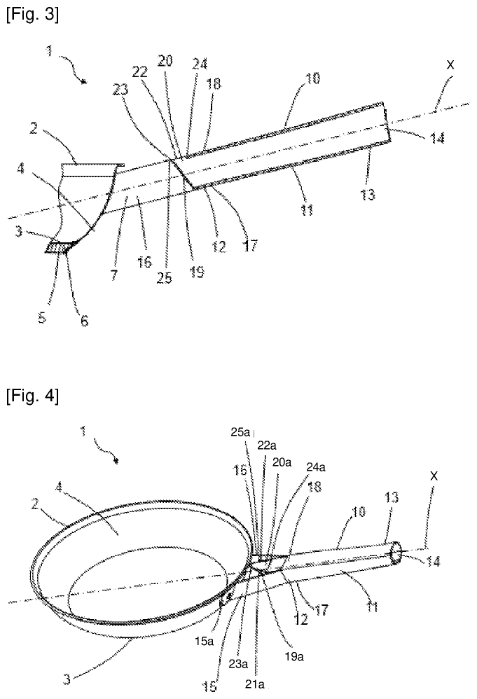

FIG. 3 is a view in cross-section along the plane III of the cooking vessel provided with the handle depicted in FIG. 1,

FIG. 4 is a perspective view of a cooking vessel provided with a tubular handle according to a second particular embodiment of the invention.

It should be noted that in this document, the terms “horizontal,” “vertical,” “lower,” “upper,” “longitudinal,” “transverse,” “top,” “bottom,” used to describe the cooking vessel provided with the handle, refer to the cooking vessel during use, when placed on a horizontal plane.

As can be seen in FIGS. 1 to 3, a cooking vessel 1 has a bowl 2 comprising a bottom 3 and a side wall 4. The bowl 2 is produced from stainless steel, for example by stamping a disk. The bottom 3 has a stainless-steel shield 5 that covers an aluminum portion 6 intended to distribute the heat (FIG. 3). The cooking vessel 1 is designed to ensure the cooking of various foods under the effect of an external source of heat. The cooking vessel 1 comprises a handle 10 arranged on the side wall 4. The cooking vessel 1 thus is portable, i.e. it can be moved manually.

The handle 10 comprises a tubular gripping part 11 that extends radially to the side wall 4 in a longitudinal direction X. The tubular gripping portion 11 has an attachment end 12 and a free end 13 provided with an orifice 14. The tubular gripping part 11 has a substantially constant transverse cross-section in the longitudinal direction X. The orifice 14 has a surface area S1 equal to the transverse cross-section.

The attachment end 12 comprises an end wall 19, a closed bottom wall 17 and an upper wall 18 provided with a through opening 20 arranged so as to be adjacent to the end wall 19. The end wall 19 is distant from the side wall 4 by at least 2 mm in order to form a channel 7 for passage of a portion of the rising hot currents that travel along the side wall during cooking.

The bottom wall 17 and the upper wall 18 respectively form half of the attachment end 12 of the tubular gripping part 11. The handle 10, particularly the attachment end 12, comprises a vertical plane of symmetry in the longitudinal direction X. As can be seen in FIG. 2, the through opening 20 has two sides 21, 22 that extend along the longitudinal direction X over 10 mm. The through opening 20 comprises an anterior part 23 closed by an upper edge 25 of the end wall 19 and a posterior part 24.

The tubular gripping part 11 only has a single through opening 20 arranged between the end wall 19 and the orifice 14, along the longitudinal direction X. The through opening 20 extends on either side of the vertical plane of symmetry in the longitudinal direction X over an average distance Z equal to 25 mm. The through opening 20 has a surface area S2=X×Z equal to 250 mm².

Advantageously, the ratio of the surface area S1 of the orifice 14 to the surface area S2 of the through opening 20 is less than 1. In this embodiment, the ratio S2/S1 is equal to 0.5.

The attachment end 12 comprises two side tabs 15, 16 that form members for attachment to the side wall 4. The two side tabs 15, 16 extend vertically in the direction of travel of the rising hot currents that travel during cooking along the side wall 4 at the location where the handle 10 is attached. The two side tabs 15, 16 extend along the longitudinal direction X, between the attachment end 12 and the side wall 4. Thus, the channel 7 is formed by the two side tabs 15, 16, the side wall 4 and the end wall 19. Each side tab 15, 16 comprises an attachment tab 15a, 16a that extends transversely to the longitudinal direction X and which is attached to the side wall 4 by riveting.

The handle 10, particularly the tubular gripping part 11, is produced from stainless steel sheet, preferably austenitic stainless steel. The handle 10, particularly the tubular gripping part 11, therefore has a substantially constant thickness equal to 1.2 mm.

During cooking, particularly on a gas stove, rising hot air currents formed in particular by the combustion gases travel along the side wall 4, particularly at the attachment end 12 of the tubular gripping part 11. The flow of hot air currents creates an overpressure on the bottom wall 17 and on the end wall 19 as well as a negative pressure on the upper wall 18 where the through opening 20 is positioned. Thus, an airflow is generated from the orifice 14 toward the through opening 20, passing through the interior of the tubular gripping part 11. Since the air received at the orifice 14 is cooler, the tubular gripping part 11 is cooled.

There is a standardized test for the temperature limits not to be exceeded on a handle of a cooking vessel used on a gas stove.

For a metal handle, this limit is established at 55° C. according to a protocol detailed in standard EN 12983-1 (Annex F). Above this temperature of 55° C., the manufacturer must advise the user to use a means of protection such as a glove or potholder to grip the handle.

The Applicant has taken temperature measurements at different measuring points over the tubular gripping part 11 of a frying pan 24 cm in diameter on a gas burner 7.5 cm in diameter. The frying pan is filled with 1.5 L of water and the gas flow rate is set at 185 L/h. Under these conditions, the temperatures are compared at a point corresponding to one-third of the length of the handle, starting from the side wall, for a standard handle corresponding to the construction described in document EP 0240225 and for an improved handle having the construction above. The improved handle 10 has a temperature 20° C. lower compared to the standard handle.

In one alternative embodiment illustrated in FIG. 4, the attachment end 12 comprises an end wall 19a in the shape of a ship's bow that extends along the longitudinal direction X. The end wall 19a is distant from the side wall 4 by at least 2 mm in order to form a channel 7 between the side wall 4, the end wall 19a and the two side tabs 15, 16. The attachment end 12 comprises a closed bottom wall 17 and an upper wall 18 provided with a through opening 20a arranged to be adjacent to the end wall 19a. The end wall 19a comprises an upper edge 25a that is V-shaped with a rounded point. The through opening 20a is formed by the upper edge 25a and has an anterior part 23 corresponding to the point of the V and two sides 21a, 22a that extend along the longitudinal direction X over 20 mm. The through opening 20a comprises a posterior part 24a that closes the V shape.

Of course, the invention is in no way limited to the embodiments described and illustrated, which have only been provided by way of example. Changes can still be made, particularly with regard to the constitution of the various elements or by substituting technical equivalents, without departing from the scope of protection of the invention.

In one alternative embodiment, the end wall comprises an upper edge that is semicircular in shape. The through opening is semicircular in shape.

1. A cooking vessel configured to be placed on a source of heat, said cooking vessel comprising: a side wall and a handle attached to said side wall by attachment members, said handle comprising a tubular gripping part extending radially to the side wall along a longitudinal direction X, said tubular gripping part having an attachment end and a free end provided with an orifice, wherein the attachment end is closed by an end wall distant from the side wall by at least 2 mm to form a channel between the side wall and the end wall and wherein the attachment end comprises a closed bottom wall and an upper wall provided with at least one through opening arranged to be adjacent to the end wall so that rising hot currents which during cooking travel along the side wall in the place where the handle is attached, create a suction at the at least one opening in order to generate an airflow from the orifice toward the interior of the tubular gripping part and thereby cool it.

2. The cooking vessel according to claim 1, wherein the attachment members comprise two side tabs extending vertically and along the longitudinal direction X, between the attachment end and the side wall.

3. The cooking vessel according to claim 1, wherein the at least one through opening extend along the longitudinal direction X over at least 5 mm.

4. The cooking vessel according to claim 1, wherein the at least one through opening has a surface area of more than 100 mm².

5. The cooking vessel according to claim 1, wherein the end wall comprises an upper edge partially defining the at least one through opening.

6. The cooking vessel according to claim 5, wherein the at least one through opening is trapezoidal in shape, wherein the base of the trapezoidal shape is formed by the upper edge, and the upper edge is distant from the side wall by at least 10 mm.

7. The cooking vessel according to claim 6, wherein the trapezoidal shape comprises two sides extending along the longitudinal direction, the upper edge as well as each side creating a zone of release of rising hot currents traveling during cooking along the side wall and around the attachment end of the tubular gripping part to generate a negative pressure above the through opening.

8. The cooking vessel according to claim 5, wherein the upper edge of the end wall is V-shaped with a rounded point.

9. The cooking vessel according to claim 1, wherein the tubular gripping part is produced from austenitic stainless steel.

10. The cooking vessel according to claim 9, wherein the tubular gripping part has a thickness of less than 3 mm.

11. The cooking vessel according to claim 1, wherein the tubular gripping part comprises only one through opening between the end wall and the orifice.

12. The cooking vessel according to claim 1, wherein it is a frying pan, saucepan, or a sauteuse.

13. The cooking vessel according to claim 1, wherein the at least one through opening extend along the longitudinal direction X over at least 10 mm.

14. The cooking vessel according to claim 1, wherein the at least one through opening has a surface area of more than 200 mm2.

15. The cooking vessel according to claim 5, wherein the at least one through opening is trapezoidal in shape, the base of the trapezoidal shape being formed by the upper edge, and the upper edge being distant from the side wall by at least 20 mm.

16. The cooking vessel according to claim 9, wherein the tubular gripping part has a thickness of less than 2 mm.
